(19) United States
(12) Patent Application Publication
(10) Pub. No.: US 2008/0122865 A1
(43) Pub. Date: May 29, 2008

(54) Method of Showing Images at Different Depths and Display Showing Images at Different Depths

(76) Inventor: Arthur Vanmoor, Miami, FL (US)

Correspondence Address: LERNER GREENBERG STEMER LLP, P O BOX 2480, HOLLYWOOD, FL, 33022-2480, US

(21) Appl. No.: 11/947,483

(22) Filed: Nov. 29, 2007

Related U.S. Application Data
(60) Provisional application No. 60/867,697, filed on Nov. 29, 2006.

(51) Int. Cl. G09G 5/00

(52) U.S. Cl. 345/619

(57) ABSTRACT

The invention is a method of showing images at different depths and a display that shows images at different depths. The method includes disposing one or more display screens, which are at least partly transparent, in front of a further display screen so that a viewer sees images displayed at different depths on the different display screens.

### CROSS-REFERENCE TO RELATED APPLICATION

This application claims the benefit under 35 U.S.C. § 119(e) of my provisional application No. 60/867,697 filed Nov. 29, 2006. As far as possible under the rules, the prior application is herewith entirely incorporated by reference.

### BACKGROUND OF THE INVENTION

1. Field of the Invention

The invention relates to a method of showing images at different depths and to a display showing images at different depths.

2. Description of the Related Art

Conventional techniques for showing still or video images in which depth can be perceived require the viewer to wear glasses with lenses that are either polarized or that have color filters so that each eye perceives a different image that is shown on the same two-dimensional display screen. One technique for perceiving depth from a display screen showing computer-animated video requires the viewer to wear liquid crystal shutter glasses.

### BRIEF SUMMARY OF THE INVENTION

It is an object of the invention to provide a method of showing images at different depths and a display showing images at different depths.

With the foregoing and other objects in view there is provided, in accordance with the invention, a method of showing images at different depths. The method includes: disposing at least one display screen, which is at least partly transparent, in front of a further display screen so that a viewer sees images displayed on the at least one display screen and on the further display screen.

In accordance with an added mode of the invention, the at least one display screen is a transparent organic light emitting diode display screen.

In accordance with an additional mode of the invention, the further display screen is a transparent organic light emitting diode display screen.

In accordance with another mode of the invention, the image shown on the at least one display screen is shifted in time with respect to a related image shown on the further display screen.

In accordance with a further mode of the invention, the attenuation of an image emitted by the further display screen is compensated by increasing the light intensity of the image shown on the further display screen with respect to the light intensity of a related image shown on the at least one display screen. The attenuation of the image emitted by the further display screen is caused by the at least one display screen.

In accordance with a further added mode of the invention, the at least one display screen is disposed in front of the further display screen by a distance enabling a viewer to perceive that the image emitted by the at least one display screen originates from a different depth than a depth at which the image emitted by the further display screen originates.

In accordance with a further additional mode of the invention, a plurality of at least partly transparent display screens are disposed in front of the further display screen at a plurality of distances enabling a viewer to perceive that a plurality of images emitted by the plurality of display screens originate from a plurality of different depths. The at least one display screen is one of the plurality of display screens.

In accordance with yet a further mode of the invention, an image emanating from behind the at least one display screen is allowed to pass through the at least one display screen by constructing the at least one display screen with transparent pixel locations.

In accordance with yet a further added mode of the invention, the images combine to form a three-dimensional image.

In accordance with another added mode of the invention, a common axis extends perpendicularly through the at least one display screen and the further display screen.

With the foregoing and other objects in view there is also provided, in accordance with the invention, a display for showing images at different depths. The display includes at least one display screen and a further display screen. The at least one display screen is at least partly transparent. The at least one display screen is disposed in front of the further display screen so that a viewer sees images displayed on the at least one display screen and on the further display screen.

In accordance with an added feature of the invention, the at least one display screen is a transparent organic light emitting diode display screen.

In accordance with an additional feature of the invention, further display screen is a transparent organic light emitting diode display screen.

In accordance with another feature of the invention, an image on the at least one display screen is shifted in time with respect to a related image shown on the further display screen.

In accordance with a further feature of the invention, a controller compensates for the attenuation of the image emitted by the further display screen. The attenuation is caused by the at least one display screen. The controller performs the compensating by increasing a light intensity of the image shown on the further display screen with respect to a light intensity of a related image shown on the at least one display screen.

In accordance with a further added feature of the invention, the at least one display screen is disposed in front of the further display screen by a distance enabling a viewer to perceive that the image emitted by the at least one display screen originates from a different depth than a depth at which the image emitted by the further display screen originates.

In accordance with a further additional feature of the invention, a plurality of at least partly transparent display screens are disposed in front of the further display screen at a plurality of distances enabling a viewer to perceive that the plurality of images emitted by the plurality of display screens originate from a plurality of different depths. The at least one display screen is one of the plurality of display screens.

In accordance with yet a further feature of the invention, the at least one display screen includes a plurality of transparent pixel locations formed therein. The plurality of transparent pixel locations allow an image emanating from behind the at least one display screen to pass through the at least one display screen.

In accordance with yet a further added feature of the invention, the images combine to form a three-dimensional image.

In accordance with yet a further additional feature of the invention, a common axis extends perpendicularly through the at least one display screen and the further display screen.

Other features which are considered as characteristic for the invention are set forth in the appended claims.

Although the invention is illustrated and described herein as embodied in a method of showing images at different depths and in a display showing images at different depths it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a perspective view showing an example of a display;

FIG. 2 is a perspective view showing another example of a display;

FIG. 3 is a diagram showing an example of a display with a controller;

FIG. 4 is a perspective view of another example of a display; and

FIG. 5 is diagram showing another example of a display.

### DESCRIPTION OF THE PREFERRED EMBODIMENTS OF THE INVENTION

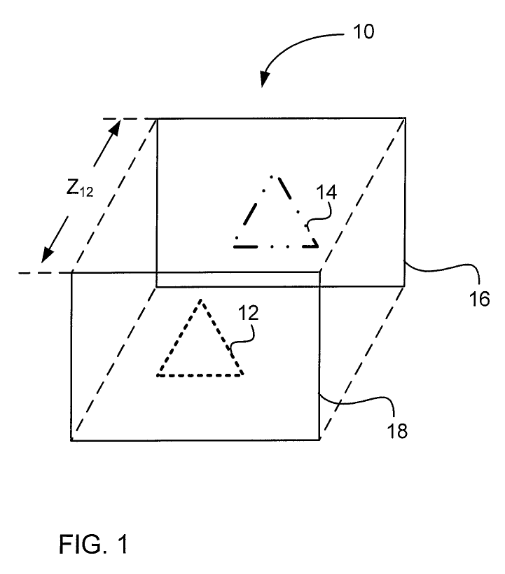

Referring now to the figures of the drawing in detail and first, particularly, to FIG. 1 thereof, there is seen a display 10 that can be used to show images 14, 12 at different depths. The display 10 includes a first display screen 16 and a second display screen 18 that is located in front of the first display screen 16 from the perspective of a viewer, or in other words, a person viewing the display 10. The distance z₁₂ separating the second display screen 18 from the first display screen 16 is sufficient to enable the viewer to distinguish between the location of an image 14 shown on the first display screen 16 and the location of an image 12 shown on the second display screen 18. Because the images 14, 12 are actually located at different distances measured along an axis extending perpendicularly through the display screens 16, 18 and extending at least somewhat near the vicinity of the viewer, the viewer can perceive that the images 14, 12 are located at different depths. The second display screen 18 is at least partly transparent so that an image 14 displayed on the first display screen 16 can be seen by a viewer looking at the second display screen 18. There is no need for special viewing lenses. It should be clear that both the first display screen 16 and the second display screen 18 (and any additional screens) are preferably fully functional multi-color display screens that can show full color images formed from a plurality of primary colors.

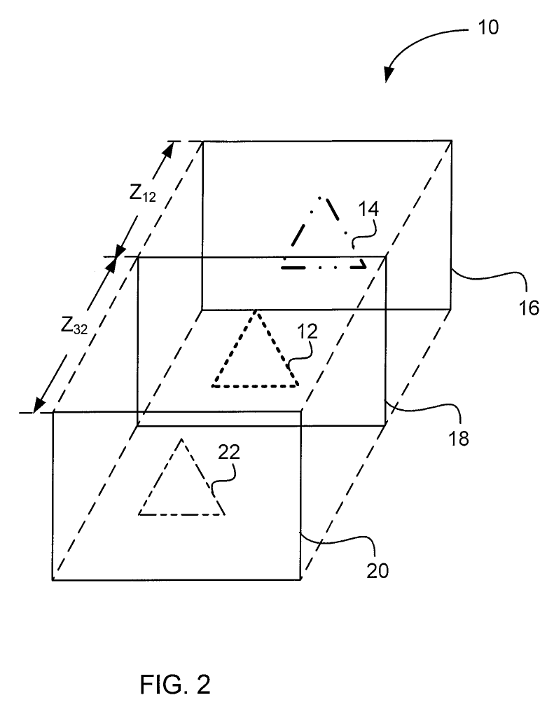

FIG. 2 shows a plurality of spatially separated, at least partly transparent display screens 18, 20 located in front of the first display screen 16. The distance z₃₂ separating the third display screen 20 from the second display screen 18 is sufficient to enable the viewer to distinguish between the location of an image 22 shown on the third display screen 20 and the location of an image 12 shown on the second display screen 18. Thus the distances z₃₂ and z₁₂ enable the viewer to distinguish between the actual locations or depths of the different images 22, 12, and 14. Although only two display screens 18, 20 are shown in front of the first display screen 16, more than two screens could be used in practice. By using a plurality of display screens 18, 20 and the first display screen 16, one increases the number of images 14, 12, 22 located at different distances measured along an axis extending perpendicularly through the display screens 16, 18 and extending at least somewhat near the vicinity of the viewer. In this manner, increased depth information can be presented for the viewer.

By appropriately spatially and temporally relating the images 14, 12, 22 on the first display screen 16 and on the one or more display screens 18, 20 to each other, the viewer can obtain sufficient depth information to perceive a three-dimensional image. It can thus be appreciated that the display 10 can be used for enabling a viewer to see three-dimensional video or still pictures.

One way of constructing the display 10 is to use transparent organic light emitting devices (transparent OLED's) for the display screens 18, 20 that are at least partly transparent. Although not absolutely necessary, it might be better to use a transparent OLED for the first display screen 16 as well so that the images 14, 12, 22 emitted from the different display screens 16, 18, 20 will have similar color characteristics and appearance. One example of a transparent OLED that can be used for the display screens 16, 18, 20 is a transparent OLED sold under the name of TOLED™, which is manufactured by Universal Display Corporation™. The TOLED™ is 70 to 85% transparent when switched off. This is nearly as transparent as the glass or plastic material on which the OLED is built.

Let us again refer to FIG. 1 to discuss the operation of the display 10 using transparent OLED's for the display screens 16, 18. In order to display two or more images on the display screens 16, 18 one could show the images 14, 12 in a time-shifted manner. For example, at a first instant of time, a first image 14 can be shown on the rear or first display screen 16. At this first instant of time, the second display screen 18 (and any additional display screens 20, for example, as shown in FIG. 2) will be switched off so that it is transparent and so that the image on the first display screen 16 can be seen through the second display screen 18 (and through any additional display screens 20). At a second instant of time, a second image 12 is presented on the second display screen 18. At the second instant of time, the first display screen 16 may be turned off, although this is not absolutely necessary. Since the first and second instants of time are very close to each other, the brain of the viewer will substantially simultaneously perceive both images 14, 12 and will recognize that the images are at different depth locations. In this manner, a three-dimensional image can be recognized. Referring again to FIG. 2, the third display screen 20 is also provided as a transparent OLED. As previously discussed, the third display screen 20 is located in front of the second display screen 18 from the perspective of the viewer. The image 22 on the third display screen 20 is shown at a third instant of time in order to show additional depth information. In this manner, the quality of the three-dimensional image is improved. The third display screen 20 is switched off to be transparent when either the first display screen 16 or the second display screen 18 is displaying an image 14, 12.

Light, which is emitted from the first display screen 16, and which then passes through the second display screen 18 will be slightly attenuated because the second display screen 18 is not perfectly transparent. If desired, one may compensate for this slight attenuation by simply increasing the light intensity of the image 14 emitted from the first display screen 16 with respect to the light intensity of the image 12 emitted from the second display screen 18. If a third display screen 20 is located in front of the second display screen 18, the light intensity of the image 14 emitted from the first display screen 16 can be increased further with respect to the intensity of the image 12 emitted from the second display screen 18. This can compensate for the attenuation caused by both the second display screen 18 and the third display screen 20. This compensation could be increased for an additional number of display screens until practical limits are reached. It should be clear that the intensity of the image emitted from the intermediate display screens will be appropriately increased with respect to the intensity of the image emitted from the front most display screen. The amount of the increase will depend upon the number of display screens through which the emitted light must pass. In this manner, the light from all of the emitted images will be output from the front-most screen at an intensity that is independent from the number of screens through which the emitted light must pass.

As has already been stated, even more display screens that are at least partly transparent could be placed in front of each other just as long as the light attenuation does not become large enough to prevent the additional images from being seen by the viewer.

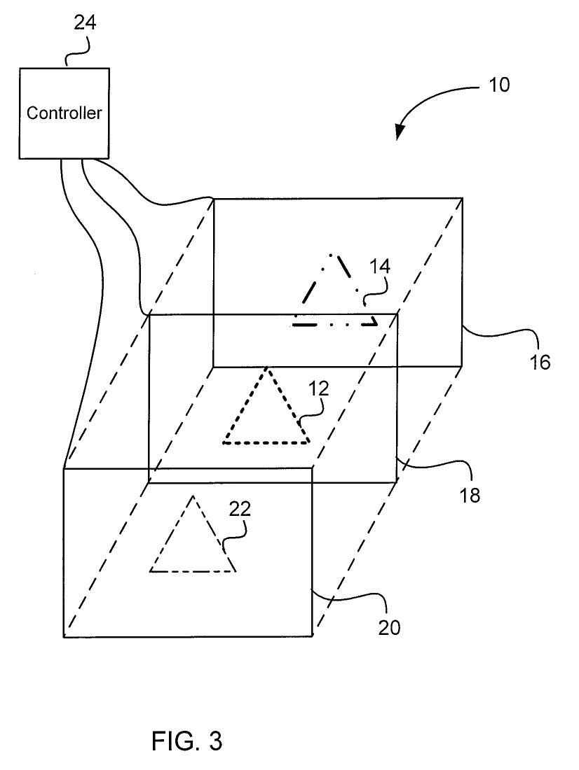

FIG. 3 is a simple diagram showing a controller 24 constructed to perform the compensating by increasing a light intensity of the image 14 shown on the first display screen 16 with respect to a light intensity of the related image 12 shown on the second display screen 18 and with respect to a light intensity of the related image 22 shown on the third display screen 20. The controller 24, of course, will also perform the compensating by increasing a light intensity of the image 12 shown on the second display screen 18 with respect to a light intensity of the related image 22 shown on the third display screen 20.

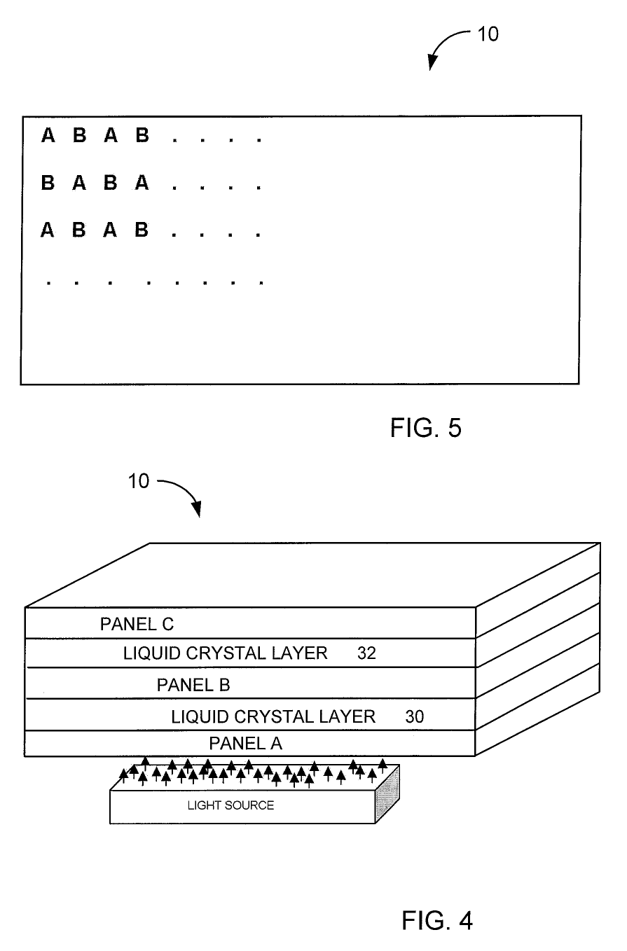

In some cases, it might be desirable to alternatively use liquid crystal displays (LCD) displays for constructing a display 10. FIG. 4 is a perspective view of another example of a display 10. Two transparent panels A, B are provided with a liquid crystal layer 30 in between. Light that shines onto the back of a first panel A (hence backlighting) is polarized at panel A and unless its polarization is rotated as it traverses the liquid crystal layer 30, the light does not continue through the second panel B. This is so because the second panel B is polarized in a transverse direction from the first panel A. In fact, then, the light is stopped at the liquid crystal layer 30, unless the crystals of the liquid crystal layer 30 “rotate” (i.e., re-polarize) the light so that it is aligned with the second panel polarization B. The crystals of the liquid crystal layer 30 polarize in given blocks that define the resolution of the display. In conventional displays, the two transparent panels A, B are polarized with 90 degree offset polarization.

According to the invention, the number of “second” panels B is increased. FIG. 4 shows two second panels B, C located in front of a first panel A. The number of liquid crystal layers 30, 32 is also accordingly increased. Each of the liquid crystal layers 30, 32 is separately driven so as to allow a “different picture” to continue through to the next (and through the last) layer.

Another possible way of constructing the display 10 is to form display screens so as to allow selected pixels of the previous screen (the screen behind it) to be seen. If the display has a resolution of, say, 10 pixels of horizontal per inch and 10 pixels of vertical per inch, the final panel (the one closest to the viewer) in a two-panel assembly would generate 5×5 pixels per square inch and would allow 5×5 pixels from the underlying panel to be visible. This organization of a display 10 showing pixels originating from panel A and from panel B, selectively, is illustrated in FIG. 5. For example, say panel A is located behind panel B. Then the locations designated as A correspond to pixels in panel A that are visible through panel B.

It should be noted, in this context, that the light injection need not necessarily originate from a back-light but that it may also be injected from the side.

In an alternative embodiment of the LCD display, the “rotation” imparted on the light passing through each of the liquid crystal layers may be somewhere between 0 and 180 degrees. We assume, here, a polarization difference between the panels of 90 degrees. Each of several liquid crystal layers may be driven with a different rotation (these may also be pulsed, for example). This makes use of the fact that the intensity of 90 degree rotated light is close to 100% while the intensity of the light with lesser or higher degree rotation is reduced.

In an alternative embodiment of the invention, the multi-level display is formed from several transparent plasma screens. In light of the increased resolutions that are now achieved with the latest models, it is possible to also run the multi-layer plasma display assembly similarly to FIG. 5 above, with lower-lying panels A showing through “holes” in the display of upper-lying panels B (and C even though not illustrated or provided in the example shown in FIG. 5). For example, consider once again the case where panel A is located behind panel B. In this case, the locations designated as A again correspond to pixels in panel A that are visible through panel B. Panel B is constructed with “holes” at the locations aligned with the pixel locations in panel A so that these pixel locations in panel A can be seen through panel B.

I claim:

1. A method of showing images at different depths, which comprises:
disposing at least one display screen, which is at least partly transparent, in front of a further display screen so that a viewer sees images displayed on the at least one display screen and on the further display screen.

2. The method according to claim 1, which further comprises: providing the at least one display screen as a transparent organic light emitting diode display screen.

3. The method according to claim 2, which further comprises: providing the further display screen as a transparent organic light emitting diode display screen.

4. The method according to claim 1, which further comprises: showing an image on the at least one display screen shifted in time with respect to a related image shown on the further display screen.

5. The method according to claim 1, which further comprises:
compensating for an attenuation of an image emitted by the further display screen by increasing a light intensity of the image shown on the further display screen with respect to a light intensity of a related image shown on the at least one display screen;
the attenuation of the image emitted by the further display screen being caused by the at least one display screen.

6. The method according to claim 1, which further comprises: disposing the at least one display screen in front of the further display screen by a distance enabling a viewer to perceive that an image emitted by the at least one display screen originates from a different depth than a depth at which an image emitted by the further display screen originates.

7. The method according to claim 1, which further comprises:
disposing a plurality of at least partly transparent display screens in front of the further display screen at a plurality of distances enabling a viewer to perceive that a plurality of images emitted by the plurality of display screens originate from a plurality of different depths;
the at least one display screen being one of the plurality of display screens.

8. The method according to claim 1, which further comprises: allowing an image emanating from behind the at least one display screen to pass through the at least one display screen by constructing the at least one display screen with transparent pixel locations.

9. The method according to claim 1, wherein: the images combine to form a three-dimensional image.

10. The method according to claim 1, wherein:
a common axis extends perpendicularly through the at least one display screen and the further display screen.

11. A display for showing images at different depths, comprising:
at least one display screen and a further display screen;
said at least one display screen being at least partly transparent; and
said at least one display screen disposed in front of said further display screen so that a viewer sees images displayed on said at least one display screen and on said further display screen.

12. The display according to claim 11, wherein said at least one display screen is a transparent organic light emitting diode display screen.

13. The display according to claim 12, wherein said further display screen is a transparent organic light emitting diode display screen.

14. The display according to claim 11, wherein an image on said at least one display screen is shifted in time with respect to a related image shown on said further display screen.

15. The display according to claim 11, further comprising:
a controller compensating for an attenuation of an image emitted by said further display screen, the attenuation caused by said at least one display screen;
said controller performing the compensating by increasing a light intensity of the image shown on said further display screen with respect to a light intensity of a related image shown on said at least one display screen.

16. The display according to claim 11, wherein:
said at least one display screen is disposed in front of said further display screen by a distance enabling a viewer to perceive that an image emitted by said at least one display screen originates from a different depth than a depth at which an image emitted by said further display screen originates.

17. The display according to claim 11, further comprising:
a plurality of at least partly transparent display screens disposed in front of said further display screen at a plurality of distances enabling a viewer to perceive that a plurality of images emitted by said plurality of display screens originate from a plurality of different depths;
said at least one display screen being one of said plurality of display screens.

18. The display according to claim 11, wherein:
said at least one display screen includes a plurality of transparent pixel locations formed therein;
said plurality of transparent pixel locations allowing an image emanating from behind said at least one display screen to pass through said at least one display screen.

19. The display according to claim 11, wherein: the images combine to form a three-dimensional image.

20. The display according to claim 11, wherein: a common axis extends perpendicularly through said at least one display screen and said further display screen.
